(19) United States
(12) Patent Application Publication
(10) Pub. No.: US 2011/0204639 A1
(43) Pub. Date: Aug. 25, 2011

(54) MODULAR POWER SYSTEM

(75) Inventor: Austin A. Shaw, Tyrone, PA (US)

(73) Assignees: Samuel Allen Shaw, Tyrone, PA (US); Emma Barbara Shaw, Tyrone, PA (US)

(21) Appl. No.: 12/712,645

(22) Filed: Feb. 25, 2010

(51) Int. Cl. F03B 13/00

(52) U.S. Cl. 290/50

(57) ABSTRACT

The present invention in several embodiments is a modular power system for providing electrical and mechanical power to a variety of applications. This system may comprise an electric motor mechanically coupled to an electric generator or alternator, and a rechargeable battery. The rechargeable battery would store and provide electrical power for the system. Additional energy could be supplied to the battery and the system by means of electrical or mechanical connections. For example, a generator of the system could be mechanically connected to the moving wheels of a land vehicle or to the moving shaft of a piece of machinery to generate electrical power. The mechanical connection could be any know in the art, but preferably would comprise a means for efficiently transferring said mechanical energy.

### FIELD OF THE INVENTION

This invention generally pertains to power systems. Specifically, the present invention relates to a modular power system for use in a variety of applications.

### BACKGROUND OF THE INVENTION

The invention is particularly applicable to power systems and will be described with particular reference thereto. However, it will be appreciated by those skilled in the art that the invention has broader applications and may also be adapted for use in power generation, vehicles and other applications.

### SUMMARY OF THE INVENTION

The present invention in several embodiments is a modular power system for providing electrical and mechanical power to a variety of applications. This system may comprise an electric motor mechanically coupled to an electric generator or alternator, and a rechargeable battery. The rechargeable battery would store and provide electrical power for the system. Additional energy could be supplied to the battery and the system by means of electrical or mechanical connections. For example, a generator of the system could be mechanically connected to the moving wheels of a land vehicle or to the moving shaft of a piece of machinery to generate electrical power. The mechanical connection could be any know in the art, but preferably would comprise a means for efficiently transferring said mechanical energy. These means could comprise, gears, transmissions, clutches, flywheels and the like. Also, the system could be adapted to provide mechanical or electrical power to other systems and devices. Mechanical transfer of power can be accomplished by any means known in the art. Electrical transfer of power can be accomplished by any means known in the art.

It is envisioned that a flywheel energy storage device (FES) could be used in the system to more efficiently transfer and covert mechanical energy. A FES works by accelerating a rotor (flywheel) to a very high speed and maintaining the energy in the system as rotational energy. When energy is extracted from the system, the flywheel's rotational speed is reduced as a consequence of the principle of conservation of energy; adding energy to the system correspondingly results in an increase in the speed of the flywheel. This energy could be extracted to generated electrical energy by means of a generator of the system.

It is also envisioned that the battery of the present invention could be replaced or supplemented by capacitors, super capacitors, flow batteries, fuel cells, or the like.

The present invention is a modular power system in that it is a scalable system whose capacity can be easily enlarged connecting two or more of the systems together to form a larger system. The modular system can be coupled mechanically and/or electrically to allow for transfer of power among the modular systems.

### OBJECTS OF THE INVENTION

It is, therefore, one of the primary objects of the present invention to provide a modular power system.

Another object of the present invention is to provide an efficient means for utilizing a rechargeable battery.

Still another object of the present invention is to provide a modular power that is scalable for use in wide range of applications.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a schematic view of a simplified preferred embodiment of the present invention.

FIG. 2 is a schematic view of a preferred embodiment of the present invention.

FIG. 3 is a schematic view of a preferred embodiment of the present invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

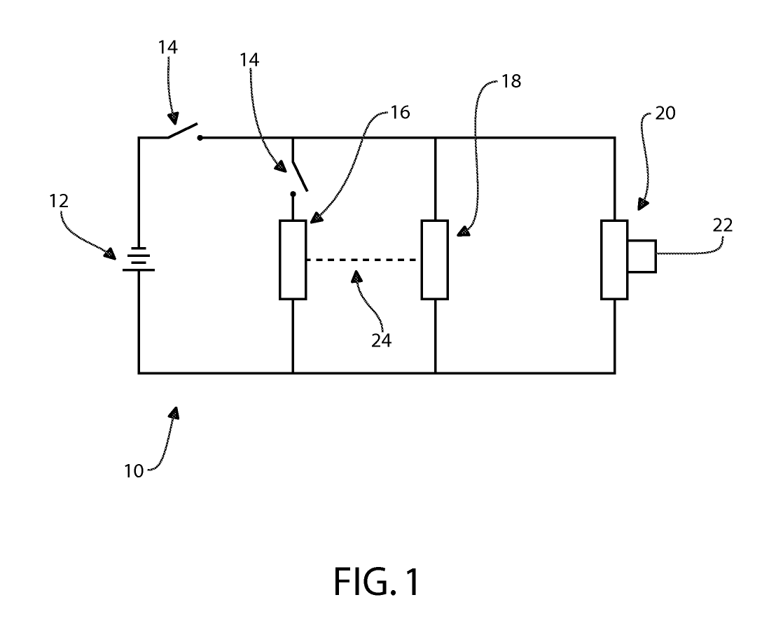

Reference is now made to FIG. 1 which shows a schematic view of a simplified preferred embodiment of the present invention. The present invention is a modular power system for supplying electrical and/or mechanical energy to a device or set of devices. Said modular power system, generally designated 10, comprises battery 12, switches 14, alternator with integral voltage regulator 16, DC motor 18, DC to AC inverter 20, AC output interface 22 and mechanical connection 24 between DC motor 18 and alternator 16. Alternator 16 could be any alternator known in the art or could be replaced with a generator depending on the specific application. Mechanical connection 24 is used to transfer mechanical energy from DC motor 18 to alternator 16. Mechanical connection 24 could be any connection known in the art that is suitable for the given application. A belt connection to the shafts of DC motor 18 to alternator 16 is preferred in some applications, but gears, drive shafts, clutches, transmissions, and other means could comprise the connection. AC output interface 22 could be any alternating current output means known in the art including but not limited to electrical sockets, electrical plugs, and the like. The present invention is also envisioned to include in some applications a means for connecting direct current (DC) powered devices. Battery 12 could be any rechargeable battery known in the art, but a lead-acid battery has shown particular promise in a variety of applications. It is believed that the higher current induced by the present invention in charging and discharging the lead-acid battery provides for enhanced and extended performance. Though this enhanced performance requires very efficient means for transferring energy throughout the system for the benefit to be realized.

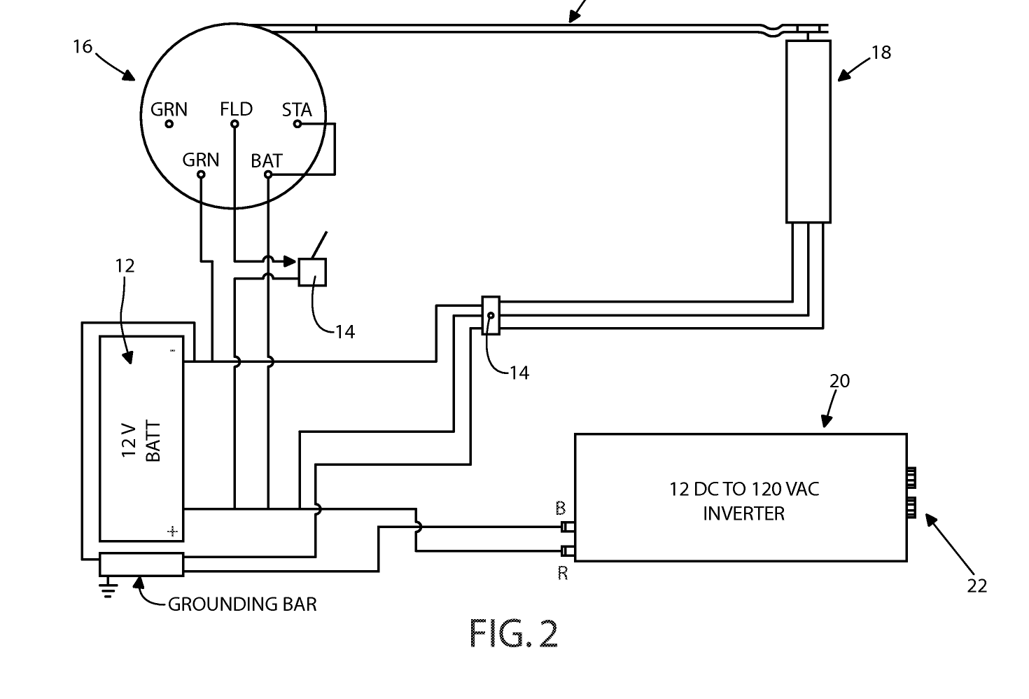

Reference is now made to FIG. 2 which shows a schematic view of a preferred embodiment of the present invention. Said modular power system, generally designated 10, comprises battery 12, switches 14, alternator with integral voltage regulator 16, DC motor 18, DC to AC inverter 20, AC output interface 22 and mechanical connection 24 between DC motor 18 and alternator 16. Alternator 16 could be any alternator known in the art. Mechanical connection 24 is used to transfer mechanical energy from DC motor 18 to alternator 16. Mechanical connection 24 could be any connection known in the art that is suitable for the given application. A belt connection to the shafts of DC motor 18 to alternator 16 is shown in the figure. AC output interface 22 could be any alternating current output means known in the art including but not limited to electrical sockets, electrical plugs, and the like. The present invention is also envisioned to include, in some applications, a means for connecting direct current (DC) powered devices. Battery 12 could be any rechargeable battery known in the art, but a lead-acid battery has shown particular promise in a variety of applications. It is believed that the higher current induced by the present invention in charging and discharging the lead-acid battery provides for enhanced and extended performance.

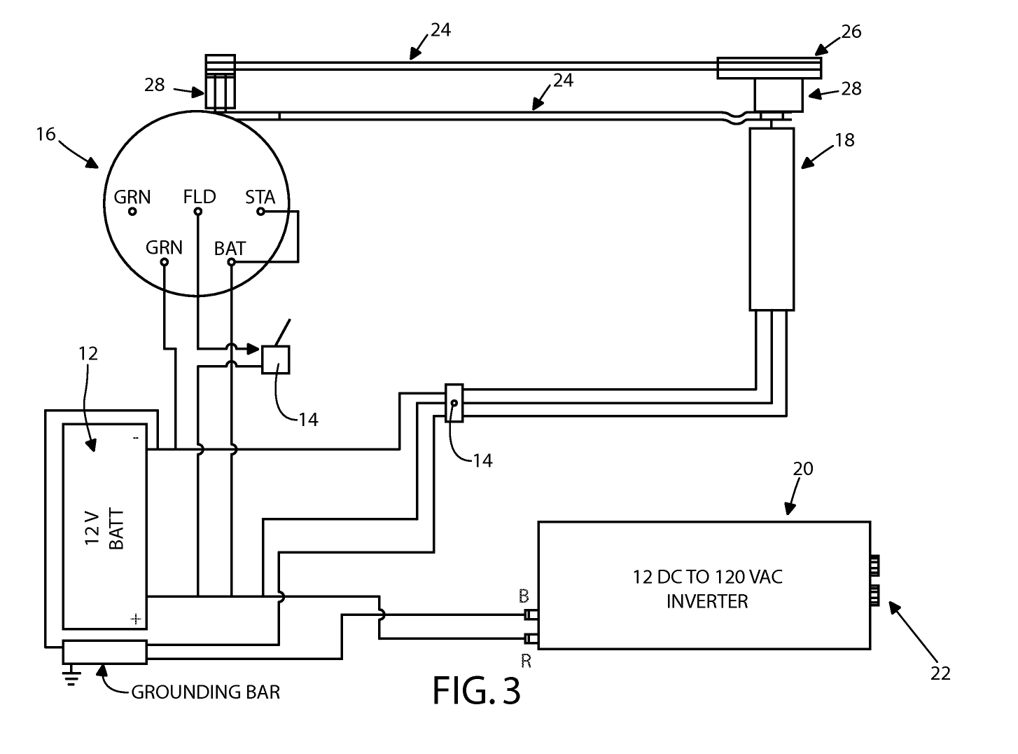

Reference is now made to FIG. 3 which shows a schematic view of a preferred embodiment of the present invention. Said modular power system, generally designated 10, comprises battery 12, switches 14, alternator with integral voltage regulator 16, DC motor 18, DC to AC inverter 20, AC output interface 22 and mechanical connection 24 between DC motor 18 and alternator 16. Alternator 16 could be any alternator known in the art. Mechanical connection 24 is used to transfer mechanical energy from DC motor 18 to alternator 16. Mechanical connection 24 could be any connection known in the art that is suitable for the given application. A belt connection to the shafts of DC motor 18 to alternator 16 is shown in the figure. Additionally, flywheel 26 could be mechanically connected to mechanical connection 24 by means of clutch assemblies 28 or any suitable means known in the art. Flywheel 26 and clutch assembly 28 could be used with or be part of a flywheel energy storage device (FES), thus enabling another energy storage device. AC output interface 22 could be any alternating current output means known in the art including but not limited to electrical sockets, electrical plugs, and the like.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A power system comprising:
at least one rechargeable battery,
at least one electric motor,
at least one generator,
at least one means for providing an electrical connection to a device,
at least one means for mechanically connecting said electric motor to said generator,
wherein said electric motor transfers mechanical energy to said generator by means of said at least one means for mechanically connecting so that said generator generates electric power from said mechanical energy.

2. The power system of claim 1, wherein said power system is modular.

3. The power system of claim 1, wherein said generator is an alternator.

4. The power system of claim 1, further comprising a fly wheel.

5. The power system of claim 1, further comprising:
a fly wheel in mechanical communication with said electric motor.

6. The power system of claim 1, further comprising:
at least one flywheel energy storage device.

7. The power system of claim 1, further comprising:
at least one direct current to alternating current inverter.

8. The power system of claim 1, wherein said at least one means for mechanically connecting said electric motor to said generator comprises a transmission.

9. The power system of claim 1, wherein said at least one means for mechanically connecting said electric motor to said generator comprises a pulley and a belt.

10. The power system of claim 1, wherein said at least one means for mechanically connecting said electric motor to said generator comprises a mechanical clutch.

11. The power system of claim 1, wherein said at least one rechargeable battery comprises a lead-acid battery.

12. A modular power system comprising:
at least one lead-acid battery,
at least one electric motor,
at least one generator,
at least one means for providing an electrical connection to a second modular power system,
at least one means for mechanically connecting said electric motor to said generator,
wherein said electric motor transfers mechanical energy to said generator by means of said at least one means for mechanically connecting so that said generator generates electric power from said mechanical energy.

13. The modular power system of claim 1, further comprising:
at least one means for providing a mechanical connection to a second modular power system.

14. The modular power system of claim 1, further comprising:
at least one means for transferring mechanical energy to a second modular power system.

15. The power system of claim 12, wherein said generator is an alternator.

16. The power system of claim 12, further comprising a fly wheel.

17. The power system of claim 12, further comprising:
a fly wheel in mechanical communication with said electric motor.

18. The power system of claim 12, further comprising:
at least one flywheel energy storage device.

19. The power system of claim 12, further comprising:
at least one direct current to alternating current inverter.

20. The power system of claim 1, wherein said at least one means for mechanically connecting said electric motor to said generator comprises a pulley and a belt.
